(19) United States
(12) Patent Application Publication
(10) Pub. No.: US 2020/0045797 A1
(43) Pub. Date: Feb. 6, 2020

(54) LIGHTING SYSTEM

(71) Applicant: PANASONIC INTELLECTUAL PROPERTY MANAGEMENT CO., LTD., Osaka (JP)

(72) Inventor: Yoshihiro OKUNO, Hyogo (JP)

(21) Appl. No.: 16/522,086

(22) Filed: Jul. 25, 2019

(30) Foreign Application Priority Data
Jul. 31, 2018 (JP) 2018-143563

(51) Int. Cl. H05B 37/02

(52) U.S. Cl. CPC H05B 37/0272

(57) ABSTRACT

A lighting system includes a luminaire, a main controller that wirelessly transmits a command to control a dimming state to the luminaire at predetermined intervals, and an auxiliary controller that includes an operation switch and wirelessly transmits a start signal and an end signal of a press-and-hold action to the main controller when the press-and-hold action is performed on the operation switch.

### CROSS REFERENCE TO RELATED APPLICATION

The entire disclosure of Japanese Patent Application No. 2018-143563 filed on Jul. 31, 2018, including the specification, claims, drawings, and abstract, is incorporated herein by reference in its entirety.

### TECHNICAL FIELD

The present disclosure relates to a lighting system.

### BACKGROUND

An existing lighting system is disclosed, for example, in Japanese Unexamined Patent Application Publication No. 2016-225175, which is directed to a lighting system that includes a plurality of luminaires and a wireless remote controller configured to individually adjust their lighting status, luminance, or any other parameters of the luminaires by a wireless command.

### SUMMARY

In a lighting system in which its luminaires are controlled by a wireless remote controller, the wireless remote controller may be configured by a main controller and an auxiliary controller. In such a case, when an operation is performed on an operation switch of the auxiliary controller, an operation signal corresponding to the operation is wirelessly transmitted to the main controller. The main controller that has received the operation signal may wirelessly transmit a command to control the lighting status of the luminaires to the luminaires at predetermined time intervals. In a lighting system with such a configuration, if the wireless transmission of the operation signal from the auxiliary controller to the main controller and the wireless transmission of the command from the main controller to the luminaire take place in synchronization with each other, the lighting system may be unsuccessful in accurately implementing the control of the luminaires due to radio frequency interference.

An advantage of the present disclosure is that a lighting system is provided that is capable of suppressing interference between wireless transmission of signals from an auxiliary controller to a main controller and wireless transmission of commands from the main controller to the luminaire, thereby accurately implementing control of luminaires.

A lighting system according to the present disclosure includes a luminaire, a main controller configured to wirelessly control a dimming state to the luminaire, and an auxiliary controller that includes an operation switch. The auxiliary controller is configured to wirelessly transmit a start signal indicating start of a press-and-hold action on the operation switch and an end signal indicating termination of the press-and-hold action to the main controller when the press-and-hold action is performed on the operation switch, and the main controller is configured to wirelessly transmit a command to control the dimming state to the luminaire at a predetermined time interval in response to receiving the start signal, and to stop transmitting the command in response to receiving the end signal. No signal is transmitted between transmitting the start signal and transmitting the end signal from the auxiliary controller to the main controller.

According to the lighting system in accordance with the present disclosure, it is made possible to prevent interference between a signal wirelessly transmitted from an auxiliary controller to a main controller and a command wirelessly transmitted from the main controller to the luminaire and accurately control luminaires.

### BRIEF DESCRIPTION OF DRAWINGS

The figures depict one or more implementations in accordance with the present teachings, by way of example only, not by way of limitations. In the figures, like reference numerals refer to the same or similar elements.

FIG. 1 is a schematic configuration diagram of a lighting system according to an embodiment of the present disclosure;

FIG. 2 is a functional block diagram of the lighting system illustrated in FIG. 1;

FIG. 3 is a flowchart illustrating the processing procedure carried out by a control unit of a main controller;

FIG. 4 is a flowchart illustrating the processing procedure carried out by a control unit of an auxiliary controller;

FIG. 5 is a flowchart illustrating another processing procedure carried out by the control unit of the main controller; and

FIG. 6 is a flowchart illustrating another processing procedure carried out by the control unit of the auxiliary controller.

### DESCRIPTION OF EMBODIMENTS

Embodiments of the present disclosure will be described in detail below with reference to the drawings. The specific shapes, materials, numerical values, directions, etc. in the description of the embodiments are merely provided for the purpose of explanations and illustrations to facilitate understanding of the present disclosure. As such, the present disclosure may be modified as appropriate in accordance with applications, purposes, specifications, etc. Also, embodiments, modified examples, and other relevant modes of implementation which may be included in the following description are to be read and understood on the premise that they may be implemented with their characteristic features combined as appropriate.

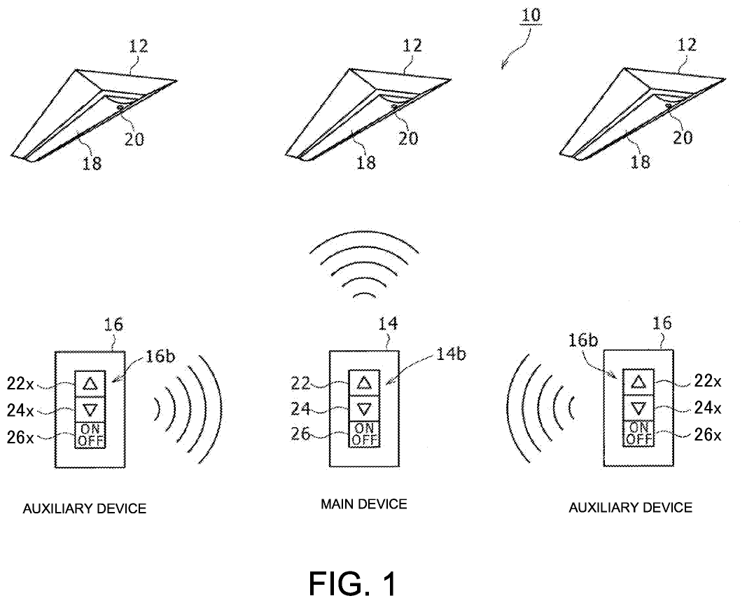

FIG. 1 is a schematic configuration diagram of a lighting system 10 according to an embodiment of the present disclosure. The lighting system 10 includes a luminaire 12, a main controller 14, and an auxiliary controller 16. The lighting system 10 may be installed in an office, a conference room, or any other spaces in a building, for example.

The luminaire 12 may be installed on a ceiling. This embodiment is described in the context of an example where the lighting system 10 includes three luminaires 12. It will be appreciated that the lighting system 10 may include only one luminaire 12, or multiple luminaires 12.

The luminaire 12 includes a light emitting unit 18 and a reception unit 20. The light emitting unit 18 may include an LED light source, for example. Illumination light is emitted from the light emitting unit 18 as the LED light source emits light.

The reception unit 20 of the luminaire 12 has a feature of receiving a command transmitted from the main controller 14. The reception unit 20 may include an antenna. The luminaire 12 and the main controller 14 perform transmission and reception of the command, for example, by wireless communication such as infrared communication. The luminaire 12 changes a lighting status of the light emitting unit 18 (i.e., the LED light source) in accordance with the command received by the reception unit 20. Specifically, the light emitting unit 18 of the luminaire 12 is turned on or off in accordance with the command Also, a dimming rate (i.e., luminance) of the light emitting unit 18 of the luminaire 12 is adjusted in accordance with the command.

The main controller 14 has a feature of wirelessly transmitting the command to the luminaire 12. The main controller 14 may be installed on a wall in a room. As will be described later, the main controller 14 transmits the command wirelessly to the luminaire 12 at predetermined intervals when a press-and-hold action is performed on an operation switch of the auxiliary controller 16.

Also, the main controller 14 according to this embodiment may include an operation switch 14b. The main controller 14 functions as a wireless remote controller that controls the lighting status of the luminaire 12 in accordance with the operation performed on the operation switch 14b. The operation switch 14b includes a dimming rate increase switch 22 that increases the dimming rate of the luminaire 12, a dimming rate decrease switch 24 that decreases the dimming rate, and a power switch 26 that enables and disables power supply to the luminaire 12. In this embodiment, three switches 22, 24, 26 are arranged in alignment with each other in the vertical direction. The switches 22, 24, 26 may be preferably configured by a switch operable by being pressed, for example.

When a press-and-hold action has been performed on the dimming rate increase switch 22 for a predetermined period of time (e.g., 20 ms) or longer, a command to increase the dimming rate by a predetermined amount (e.g., 1%) is transmitted at predetermined time intervals (e.g., 3 ms) from the main controller 14 to the luminaire 12. Meanwhile, when a press-and-release action, i.e., an operation of pressing for a short period of time (e.g., shorter than 20 ms) and releasing, is performed on the dimming rate increase switch 22 instead of the press-and-hold action, a command to increase the dimming rate by a predetermined amount each time the pressing operation is performed is transmitted from the main controller 14 to the luminaire 12.

When the press-and-hold action has been performed on the dimming rate decrease switch 24, i.e., when the dimming rate decrease switch 24 is pressed continuously for a predetermined period of time (e.g., 20 ms) or longer, a command to decrease the dimming rate by a predetermined amount (e.g., 1%) is transmitted at predetermined time intervals (e.g., 3 ms) from the main controller 14 to the luminaire 12. Meanwhile, when the press-and-release action for a short period of time (e.g., less than 20 ms) is performed on the dimming rate decrease switch 24 instead of the press-and-hold action, then a command to decrease the dimming rate by a predetermined amount each time the pressing operation is performed is transmitted from the main controller 14 to the luminaire 12.

When the power switch 26 is pressed, the luminaire 12 is turned on or off (electrical power is supplied to the luminaire 12 or the supply of the electrical power supplied to the luminaire 12 is stopped). Accordingly, the luminaire 12 is turned on when the power switch 26 is pressed while the luminaire 12 is placed in an unlit state, and the luminaire 12 is turned off when the power switch 26 is pressed while the luminaire 12 is placed in a lit state.

The main controller 14 is configured to wirelessly control a dimming state to the luminaire 12. Also, the main controller 14 is configured to wirelessly transmit a command to control the dimming state to the luminaire 12 at a predetermined time interval in response to reception of the start signal indicating start of a press-and-hold action on the operation switch of the auxiliary controller 16, and to stop transmitting the command in response to reception of the end signal indicating termination of the press-and-hold action.

The auxiliary controller 16 of the lighting system 10 has an operation switch 16b. Whilst this embodiment is described in the context of an example where the lighting system 10 includes two auxiliary controllers 16, the number of the auxiliary controllers 16 is not limited to the illustrated example. Only one auxiliary controller 16 may be provided, or three or more auxiliary controllers 16 may be provided. The auxiliary controller 16 may be installed on a wall in a room. Alternatively, the auxiliary controller 16 may be a portable wireless remote controller.

The operation switch 16b of the auxiliary controller 16 includes a dimming rate increase switch 22x that increases the dimming rate of the luminaire 12, a dimming rate decrease switch 24x that decreases the dimming rate, and a power switch 26x that enables and disables power supply to the luminaire 12. The functions of these switches 22x, 24x, 26x are the same as those of the operation switch 14b of the main controller 14. Meanwhile, the auxiliary controller 16 differs from the main controller 14 in that, when an operation is performed on the operation switch 16b of the auxiliary controller 16, a signal corresponding to the operation is transmitted not to the luminaire 12 but to the main controller 14 wirelessly, for example, using infrared communication.

Specifically, the dimming rate increase switch 22x or the dimming rate decrease switch 24x of the auxiliary controller 16 is pressed for short period of time (e.g., less than 20 ms), a signal for increasing or decreasing the dimming rate is transmitted from the auxiliary controller 16 to the main controller 14. The main controller 14 which has received the signal generates a command to increase or decrease the dimming rate and wirelessly transmits the command to the luminaire 12. Meanwhile, as will be described later in detail, the auxiliary controller 16 is configured to wirelessly transmit a start signal indicating start of a press-and-hold action and an end signal indicating termination of the press-and-hold action to the main controller 14 when the press-and-hold action is performed on the operation switch 16b.

Also, when a press-and-hold action has been performed on the operation switch 16b, for example, the dimming rate increase switch 22x or the dimming rate decrease switch 24x, the auxiliary controller 16 wirelessly transmits only a start signal and an end signal of the press-and-hold action to the main controller 14. Namely, in the lighting system 10, no signal is transmitted from the auxiliary controller 16 to the main controller 14 between transmission of the start signal of the press-and-hold action and transmission of the end signal of the press-and-hold action. In other words, the auxiliary controller 16 is configured not to transmit an operation signal to the main controller 14 until transmission of the end signal, when the auxiliary controller 16 transmits the start signal to the main controller 14.

When a pressing operation has been performed on the power switch 26x of the auxiliary controller 16, the power supply signal or the power stop signal is wirelessly transmitted from the auxiliary controller 16 to the main controller 14. The main controller 14 which has received the power supply signal or the power stop signal generates and wirelessly transmits a command to start or stop the power supply to the luminaire 12.

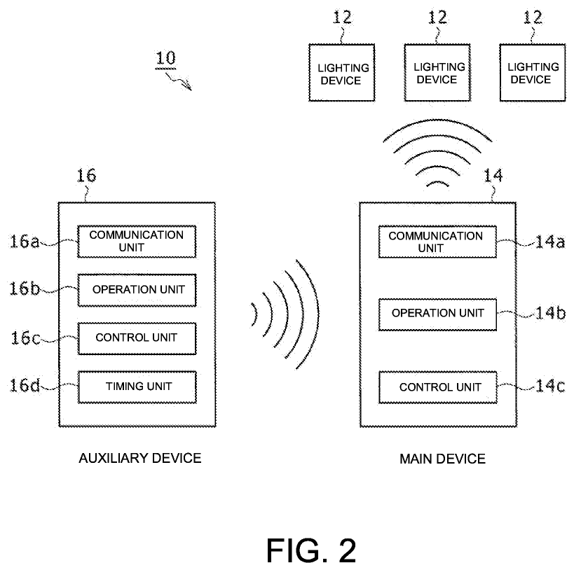

FIG. 2 is a functional block diagram of the lighting system 10 illustrated in FIG. 1. Note that FIG. 2 only illustrates one single auxiliary controller 16.

As illustrated in FIG. 2, the main controller 14 includes a communication unit 14a, an operation switch 14b, and a control unit 14c. The communication unit 14a has a feature of transmitting a command to the luminaire 12 and a feature of receiving a signal transmitted from the auxiliary controller 16. The operation switch 14b is configured by the dimming rate increase switch 22, the dimming rate decrease switch 24, and the power switch 26 as described above.

The control unit 14c may be preferably configured by a microcontroller that includes a memory unit, for example. The control unit 14c is capable of reading and running programs stored in the memory unit. Programs related to control of the lighting system 10 are previously stored in the memory unit.

As illustrated in FIG. 2, the auxiliary controller 16 in this embodiment includes a communication unit 16a, an operation switch 16b, a control unit 16c, and a timing unit 16d. The communication unit 16a has a feature of wirelessly transmitting a signal to the main controller 14. The operation switch 16b is comprised of the dimming rate increase switch 22x, the dimming rate decrease switch 24x, and the power switch 26x as described above.

The control unit 16c determines that the press-and-hold action is performed on the operation switch 16b, when the state in which the operation switch 16b is pressed continues for a predetermined time (e.g., 20 ms) or longer, for example. Also, the control unit 16c determines that the short press action is performed on the operation switch 16b, when the state in which the operation switch 16b is pressed continues for less than the predetermined period, for example. In this case, the predetermined period is a threshold of long press action and short press action.

The control unit 16c may be preferably configured by a microcontroller that includes a memory unit. The control unit 16c is capable of reading and running programs stored in the memory unit. Programs related to control of the lighting system 10 are previously stored in the memory unit.

The timing unit 16d has a feature of measuring time. The timing unit 16d may be preferably configured by a timing counter. The timing unit 16d is configured to measure, for example, the time elapsed since the transmission of the start signal of the press-and-hold action in the operation switch 16b of the auxiliary controller 16 as will be described later.

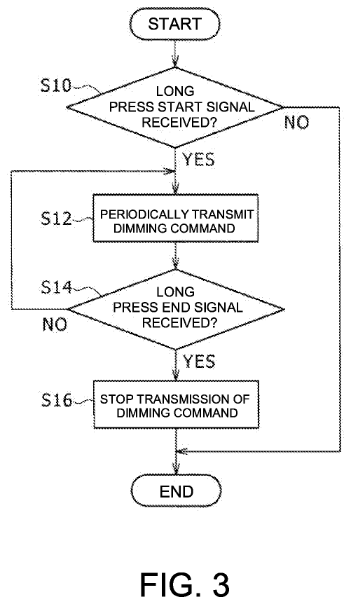

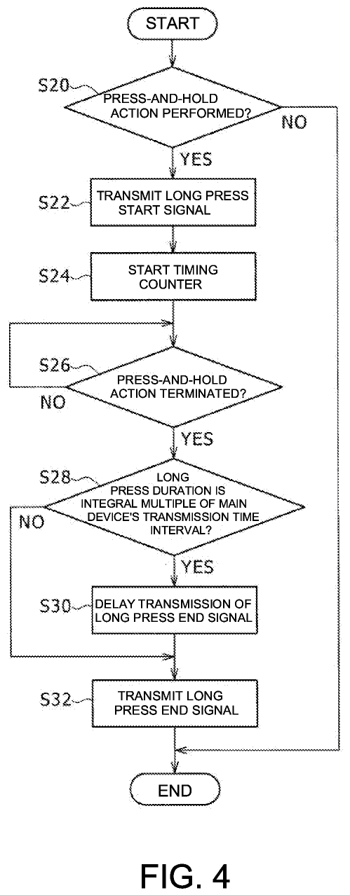

Next, the operation of the lighting system 10 according to this embodiment will be described with reference to FIGS. 3 and 4. FIG. 3 is a flowchart illustrating a processing procedure carried out by the control unit 14c of the main controller 14. The processing illustrated in FIG. 3 is repeatedly carried out for each predetermined period of time while the luminaire 12 is placed in the lit state.

As illustrated in FIG. 3, the control unit 14c of the main controller 14 determines in step S10 whether or not a long press start signal has been received from the auxiliary controller 16. Here, the long press start signal is wirelessly transmitted from the communication unit 16a of the auxiliary controller 16 to the main controller 14 when a predetermined period of time (e.g., 20 ms) has elapsed from the time at which a pressing operation is performed on the dimming rate increase switch 22x or the dimming rate decrease switch 24x in the operation switch 16b of the auxiliary controller 16.

When the control unit 14c of the main controller 14 has determined that the long press start signal has not been received (NO in the step S10), the control unit 14c terminates the processing without any further steps (termination processing). Meanwhile, when the control unit 14c of the main controller 14 has determined that the long press start signal has been received (YES in the step S10), then the control unit 14c in the following step S12 periodically transmits dimming commands from the communication unit 14a to the luminaire 12. Specifically, the control unit 14c transmits commands causing the dimming rate to be increased by a predetermined amount (e.g., 1%) at predetermined time intervals (e.g., 3 ms) while a press-and-hold action (long press action) is being performed on the dimming rate increase switch 22x of the auxiliary controller 16. Meanwhile, when a press-and-hold action is being performed on the dimming rate decrease switch 24x of the auxiliary controller 16, the control unit 14c transmits commands causing the dimming rate to be decreased by a predetermined amount (e.g., 1%) at predetermined time intervals (e.g., 3 ms).

Subsequently, the control unit 14c of the main controller 14 determines whether or not a long press end signal has been received from the auxiliary controller 16 in the step S14. Here, when the pressing operation on the dimming rate increase switch 22x or the dimming rate decrease switch 24x is terminated in the operation switch 16b of the auxiliary controller 16, then the long press end signal is wirelessly transmitted from the communication unit 16a of the auxiliary controller 16 to the main controller 14.

When the control unit 14c of the main controller 14 has determined that the long press end signal has not been received (NO in the step S14), then the control unit 14c goes back to step S12 to continue to transmit the dimming commands. In contrast, when the control unit 14c of the main controller 14 has determined that the long press end signal has received (YES in the step S14), then the control unit 14c stops transmitting the dimming command in the following step S16. It should be noted that the dimming rate at this point may be stored in the memory unit of the control unit 14c and used as the dimming rate when the luminaire 12 is turned on next time.

FIG. 4 is a flowchart illustrating the processing procedure carried out by the control unit 16c of the auxiliary controller 16. The processing illustrated in FIG. 4 is repeatedly carried out for each predetermined period of time while the luminaire 12 is placed in the lit state.

As illustrated in FIG. 4, the control unit 16c of the auxiliary controller 16 determines in step S20 whether or not a press-and-hold action has been performed on the dimming rate increase switch 22x or the dimming rate decrease switch 24x of the operation switch 16b. Here, the control unit 16c of the auxiliary controller 16 may determine that the press-and-hold action has been performed when the state where the pressing operation is performed on the dimming rate increase switch 22x or the dimming rate decrease switch 24x continues for a predetermined period of time (e.g., 20 ms) or longer. It should be noted that the period of time of the pressing operation on the dimming rate increase switch 22x or the dimming rate decrease switch 24x can be measured by the timing unit 16d.

When the control unit 16c of the auxiliary controller 16 does not determine that the press-and-hold action has been performed on the dimming rate increase switch 22x or the dimming rate decrease switch 24x (NO in the step S20), the control unit 16c terminates the processing without any further steps (termination processing). Meanwhile, when the control unit 16c of the auxiliary controller 16 has determined that the press-and-hold action has been performed on the dimming rate increase switch 22x or the dimming rate decrease switch 24x (YES in the step S20), the control unit 16c transmits the long press start signal from the communication unit 16a to the main controller 14 in the following step S22.

Subsequently, the control unit 16c of the auxiliary controller 16, in the step S24, starts the timing counter constituting the timing unit 16d and measures time. In addition, the control unit 16c of the auxiliary controller 16 determines, in step S26, whether or not the press-and-hold action has been terminated. The termination of the press-and-hold action can be determined based on whether or not the pressing operation on the dimming rate increase switch 22x or the dimming rate decrease switch 24x is terminated and the switch is turned off.

The control unit 16c of the auxiliary controller 16 waits until it is determined that the press-and-hold action on the dimming rate increase switch 22x or the dimming rate decrease switch 24x has been terminated (NO in the step S26). In addition, when the control unit 16c of the auxiliary controller 16 has determined that the press-and-hold action on the dimming rate increase switch 22x or the dimming rate decrease switch 24x has been terminated (YES in step S26), the control unit 16c determines in the following step S28 whether or not the long press duration measured by the timing unit 16d is an integral multiple of the command transmission time interval of the main controller 14.

Here, the determination of whether or not the long press duration measured by the timing unit 16d is an integral multiple of the command transmission time interval of the main controller 14 is to be made for the following reason. Specifically, transmission of the command from the main controller 14 is performed at predetermined time intervals, so that an integral multiple of this predetermined time interval can be identified as the period of time in which commands are transmitted from the main controller 14. Accordingly, when it is determined, in the step S28, whether or not the long press duration measured by the timing unit 16d is an integral multiple of the command transmission time interval of the main controller 14, it is made possible to determine whether or not the time point at which the long press end signal is transmitted coincides with the command transmission time from the main controller 14.

When it has been determined that the long press duration is an integral multiple of the command transmission time interval of the main controller 14 (YES in step S28), the control unit 16c of the auxiliary controller 16 delays, in the following step S30, the transmission of the long press end signal from the communication unit 16a to the main controller 14. Specifically, when the command transmission time interval of the main controller 14 is, for example, 3 ms, then the control unit 16c of the auxiliary controller 16 delays the transmission of the long press end signal, for example, by 1 ms or 2 ms.

In addition, the control unit 16c of the auxiliary controller 16 transmits, in the following step S32, a long press end signal from the communication unit 16a to the main controller 14. As a result of this, the end signal of the press-and-hold action will be transmitted at a time point out of synchronization with the command transmission time of the main controller 14. As a consequence, it is made possible to suppress interference between the long press end signal wirelessly transmitted from the auxiliary controller 16 and the command wirelessly transmitted from the main controller 14, as a result of which dimming control of the luminaire 12 can be effectively and reliably implemented.

After transmission of the end signal of the press-and-hold action, the control unit 16c of the auxiliary controller 16 resets the count value of the timing unit 16d and terminates the processing (termination processing).

As described in the foregoing, the lighting system 10 according to this embodiment includes the luminaire 12, the main controller 14 configured to wirelessly transmit commands to control the dimming state to the luminaire 12 at predetermined time intervals, and the auxiliary controller 16 that includes the operation switch 16b and is configured to wirelessly transmit only the start signal and the end signal of the press-and-hold action to the main controller 14 when the press-and-hold action is performed on the operation switch 16b. According to these features, when the press-and-hold action is performed on the operation switch 16b of the auxiliary controller 16, only the start signal and the end signal of the press-and-hold action are transmitted from the auxiliary controller 16 to the main controller 14, while wireless transmission of a signal is not performed. Accordingly, interference with the command wirelessly transmitted from the main controller 14 is less likely to occur, as a result of which dimming control of the luminaire 12 can be effectively and reliably implemented.

In the lighting system 10 according to this embodiment, the auxiliary controller 16 measures the time that has elapsed since the transmission of the start signal of the press-and-hold action, identifies, from the measured time, the time at which the main controller 14 wirelessly transmits the command, and transmits the end signal of the press-and-hold action to the main controller 14 at a time point out of synchronization with the time at which the main controller 14 transmits the command. According to these features, it is made possible to suppress interference between the long press end signal wirelessly transmitted from the auxiliary controller 16 and the command wirelessly transmitted from the main controller 14, as a result of which dimming control of the luminaire 12 can be effectively and reliably implemented.

Also, in the lighting system 10 according to this embodiment, the auxiliary controller 16 may measure an elapsed time since transmission of the start signal of the press-and-hold action, and transmit the end signal of the press-and-hold action to the main controller 14 at a time point out of synchronization with the time at which the main controller 14 transmits the command when a period of time from start of the press-and-hold action to end of the press-and-hold action is an integral multiple of the interval at which the command is wirelessly transmitted. According to these features, it is made possible to transmit the long press end signal from the auxiliary controller 16 at a time point out of synchronization with the time at which the main controller 14 transmits the command. As a consequence, it is made possible to suppress interference between the long press end signal wirelessly transmitted from the auxiliary controller 16 and the command wirelessly transmitted from the main controller 14, as a result of which dimming control of the luminaire 12 can be effectively and reliably implemented.

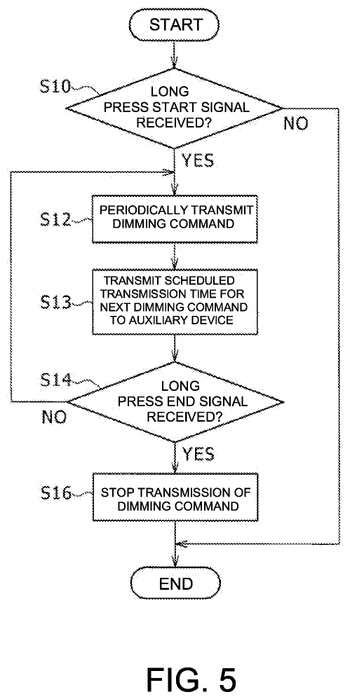

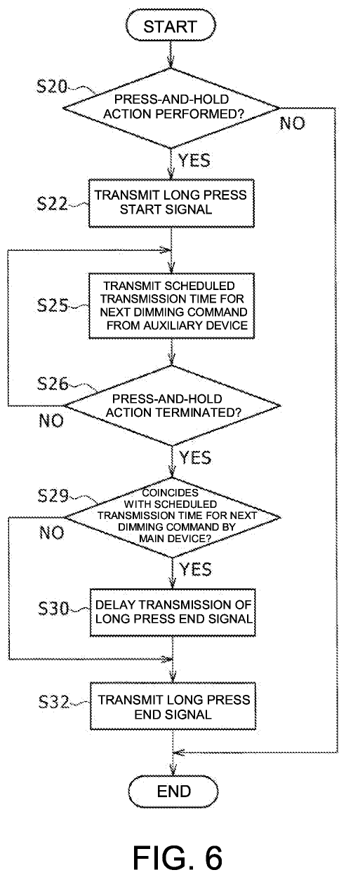

Next, other processes carried out by the main controller 14 and the auxiliary controller 16 of the lighting system 10 according to this embodiment will be described below with reference to FIGS. 5 and 6. FIG. 5 is a flowchart illustrating another processing procedure carried out by the control unit 14c of the main controller 14. FIG. 6 is a flowchart illustrating another processing procedure carried out by the control unit 16c of the auxiliary controller 16.

The processing procedures of FIGS. 5 and 6 are similar to those described in the foregoing with reference to FIGS. 3 and 4. Accordingly, the same reference signs are assigned to the same processing steps as those in the processing procedures of FIGS. 3 and 4, and detailed description thereof will not be repeated. The following description will focus on the different aspects of the processing procedures.

As illustrated in FIG. 5, after the control unit 14c of the main controller 14 has transmitted the dimming command in the step S12, the control unit 14c transmits, in step S13, a scheduled transmission time for the next dimming command from the communication unit 14a to the auxiliary controller 16. In addition, the control unit 14c of the main controller 14 repeatedly carries out steps S12, S13 until receiving a long press end signal from the auxiliary controller 16. The remaining processing steps are the same as those of the processing procedure illustrated in FIG. 3.

As illustrated in FIG. 6, after having transmitted the long press start signal in the step S22, the control unit 16c of the auxiliary controller 16 receives the scheduled transmission time to transmit the next dimming command from the main controller 14 in the step S25. In addition, the control unit 16c of the auxiliary controller 16 repeatedly carries out the processing at steps S25, S26 until the press-and-hold action is terminated.

When the press-and-hold action upon the operation switch 16b of the auxiliary controller 16 is terminated (YES in step S26), the control unit 16c of the auxiliary controller 16 determines, in the following step S29, whether or not the time point at which the press-and-hold action are terminated coincides with the next scheduled command transmission time of the main controller 14. Here, if it has been determined that the time point coincides with the next scheduled command transmission time (YES in step S29), the control unit 16c of the auxiliary controller 16 delays the transmission of the long press end signal in the following step S30. The processing after this step will proceed as illustrated in FIG. 4.

As described above, according to the lighting system 10 according to this embodiment, the main controller 14 wirelessly transmits the next scheduled command transmission time to the auxiliary controller 16 and the auxiliary controller 16 wirelessly transmits the end signal of the press-and-hold action to the main controller 14 at a time point out of synchronization with the scheduled command transmission time. According to these features, the auxiliary controller 16 can accurately identify the next scheduled command transmission time for the main controller 14 to transmit the next command. Accordingly, it is made possible to more effectively and reliably carry out transmission of the end signal of the press-and-hold action to the main controller 14 at a time point out of synchronization with the time at which the main controller 14 transmits the command. As a consequence, it is made possible to suppress interference between the long press end signal wirelessly transmitted from the auxiliary controller 16 and the command wirelessly transmitted from the main controller 14, which makes it possible to more effectively and reliably carry out the dimming control of the luminaire 12.

Also, according to the lighting system 10 in accordance with this embodiment that includes the luminaire 12, the main controller 14, and the auxiliary controller 16, the main controller 14 may wirelessly transmit a command to control a dimming state to the luminaire 12 at predetermined time intervals. The main controller may transmit a next transmission time to transmit a next command to the auxiliary controller 16 after having received a long press start signal (first signal) from the auxiliary controller 16. The auxiliary controller 16 may have an operation switch 16b, transmit the long press start signal to the main controller 14 in response to a press-and-hold action being performed on the operation switch 16b, receive the next transmission time from the main controller 14, and, in response to the press-and-hold action on the operation switch 16b being terminated, wirelessly transmit a long press end signal (second signal) to the main controller 14 at a time point out of synchronization with the next transmission time.

In this case, the main controller 14 may transmit the next transmission time to transmit a command to be transmitted to the auxiliary controller 16 every time the main controller 14 transmits the command to control the dimming state to the luminaire 12 until the main controller 14 receives the long press end signal from the auxiliary controller 16.

Also, according to the lighting system 10 that includes the luminaire 12, the main controller 14, and the auxiliary controller 16, the main controller 14 may wirelessly transmit a command to control a dimming state to the luminaire 12 at predetermined time intervals. The auxiliary controller 16 may include an operation switch 16b, measure an interval at which the main controller 14 transmits the command, and wirelessly transmit a signal indicating that the operation switch 16b has been operated to the main controller 14 at a time point out of synchronization with the time at which the main controller 14 transmits the command.

In this case, the signal indicating that the operation switch 16b has been operated may be either a signal indicating that a press-and-hold action has been performed on the operation switch 16b or a signal indicating that the press-and-hold action of the operation switch 16b has been terminated.

It should be noted that the lighting system according to the present disclosure is not limited to the above-described embodiments and modified examples thereof and various modifications and improvements may be made thereto within the range of the matters described in the claims of the present disclosure.

For example, the processing procedure described with reference to FIGS. 5 and 6 has been described based on an example where the main controller 14 repeatedly transmits the scheduled transmission time to transmit the next dimming command to the auxiliary controller 16 until it receives the long press end signal, but the present disclosure is not limited to this example. The main controller 14 may be configured to transmit only one scheduled transmission time to transmit the next dimming command to the auxiliary controller 16. In this case, the control unit 16c of the auxiliary controller 16 can compute the time at which the command is transmitted from the main controller 14 after the received next scheduled command transmission time, by adding, to the received next scheduled command transmission time, an integral multiple of the predetermined time interval at which the command is transmitted. Accordingly, in this case as well, it is made possible to cause the time point at which the long press end signal is to be transmitted from the auxiliary controller 16 to the main controller 14 to be out of synchronization with the scheduled command transmission time. As a consequence, it is made possible to suppress interference between the long press end signal wirelessly transmitted from the auxiliary controller 16 and the command wirelessly transmitted from the main controller 14, which makes it possible to more effectively and reliably carry out the dimming control of the luminaire 12.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting system comprising:
a luminaire;
a main controller configured to wirelessly control a dimming state to the luminaire; and
an auxiliary controller that includes an operation switch, wherein:
the auxiliary controller is configured to wirelessly transmit a start signal indicating start of a press-and-hold action on the operation switch and an end signal indicating termination of the press-and-hold action to the main controller when the press-and-hold action is performed on the operation switch,
the main controller is configured to wirelessly transmit a command to control the dimming state to the luminaire at a predetermined interval in response to receiving the start signal, and to stop transmitting the command in response to receiving the end signal, and
no signal is transmitted between the start signal and the end signal from the auxiliary controller to the main controller.

2. The lighting system according to claim 1, wherein the auxiliary controller measures an elapsed time since transmission of the start signal, obtains from the measured elapsed time a time at which the main controller wirelessly transmits the command, and transmits the end signal to the main controller at a time point out of synchronization with the time at which the main controller transmits the command.

3. The lighting system according to claim 1, wherein:
the main controller wirelessly transmits a next scheduled command transmission time to the auxiliary controller, and
the auxiliary controller wirelessly transmits the end signal to the main controller at a time point out of synchronization with the scheduled command transmission time.

4. The lighting system according to claim 2, wherein the auxiliary controller measures an elapsed time since transmission of the start signal, and transmits the end signal to the main controller at a time point out of synchronization with the time at which the main controller transmits the command when a period of time from the start of the press-and-hold action to the termination of the press-and-hold action is an integral multiple of the predetermined interval at which the command is wirelessly transmitted.

5. A lighting system comprising a luminaire, a main controller, and an auxiliary controller, wherein
the main controller configured to
wirelessly transmits a command to control a dimming state to the luminaire at a predetermined time interval, and
transmits a next transmission time to transmit a next command to the auxiliary controller after receiving a first signal from the auxiliary controller, and
the auxiliary controller
includes an operation switch,
configured to transmits the first signal to the main controller in response to a press-and-hold action being performed on the operation switch,
receives the next transmission time from the main controller, and
in response to the press-and-hold action on the operation switch being terminated, wirelessly transmits a second signal to the main controller at a time point out of synchronization with the next transmission time.

6. The lighting system according to claim 5, wherein the main controller transmits a next transmission time of the command to control the dimming state to the auxiliary controller every time the main controller transmits the command to the luminaire until the main controller receives the second signal from the auxiliary controller.

7. A lighting system comprising a luminaire, a main controller, and an auxiliary controller, wherein
the main controller configured to
wirelessly transmits a command to control a dimming state to the luminaire at predetermined time intervals, and
the auxiliary controller
includes an operation switch,
configured to measures an interval at which the main controller transmits the command, and
wirelessly transmits a signal indicating that the operation switch is operated to the main controller at a time point out of synchronization with the time at which the main controller transmits the command.

8. The lighting system according to claim 7, wherein the signal indicating that the operation switch is operated is either a signal indicating that a press-and-hold action is started on the operation switch or a signal indicating that the press-and-hold action of the operation switch is terminated on the operation switch.
